(19) United States
(12) Patent Application Publication
(10) Pub. No.: US 2021/0370541 A1
(43) Pub. Date: Dec. 2, 2021

(54) ULTRASONIC VIBRATION ASSISTED MACHINING DEVICE

(71) Applicant: National Taiwan University, Taipei City (TW)

(72) Inventors: Yunn-Shiuan LIAO, Taipei City (TW); Chao-Hsin WANG, Taipei City (TW); Chang-Cheng KO, Taipei City (TW)

(21) Appl. No.: 17/330,254

(22) Filed: May 25, 2021

(30) Foreign Application Priority Data
May 27, 2020 (CN) 202010458755.1

(51) Int. Cl. B26D 7/08; B06B 1/02

(52) U.S. Cl. CPC B26D 7/086; B06B 1/0215

(57) ABSTRACT

An ultrasonic vibration assisted machining device is applied to a cutting tool and includes a vibrating component and a spinning component. The vibrating component includes a main body including a first end surface, a second end surface and a central axis. The vibrating component is configured to receive electrical power and generate a vibration with a vibrating frequency in the central axis direction according to the electrical power. The spinning component includes a first surface connected to the second end surface of the vibrating component. The area of the first surface is greater than that of the second end surface. The spinning component generates a spinning motion centered on the central axis according to the vibration with the vibrating frequency generated by the vibrating component. Wherein, the spinning component transmits the vibration and the spinning motion to the cutting tool.

### BACKGROUND OF THE INVENTION

### 1. Field of the Invention

The present invention relates to a machining device, and more specifically, to an ultrasonic vibration assisted machining device that can increase the cutting performance of the cutting tool.

### 2. Description of the Prior Art

The ultrasonic vibration assisted machining is one of the nontraditional machining methods in the field of material removal for shape production. It is a combination of ultrasonic vibration and traditional machining methods. In the ultrasonic vibration assisted machining process high-frequency ultrasonic vibration is applied on the cutting tool or the workpiece, and the material is removed by the mechanical energy of the ultrasonic vibration. Compared with other machining methods, the ultrasonic vibration assisted machining has the advantages of low cutting force, less tool wear, and low cutting temperature. In addition, the workpiece is impacted and abraded by many abrasives of the tool, and hence it is also suitable for machining various hard and brittle materials. As a result, the ultrasonic vibration assisted machining has been widely applied in many industries.

In general, the cutting tool or workpiece only vibrates in a single direction which is perpendicular to the workpiece surface in the ultrasonic vibration assisted milling process. That is to say, the workpiece is subjected to the vertical impact of the cutting tool. Since the material is removed by the point-to-point process, a relatively uneven surface is produced, and the machining accuracy is reduced. Hence, if the cutting tool can vertically strike and grind the workpiece at the same time, the quality of the workpiece and the machining efficiency can be improved.

In the prior art, the ultrasonic vibration assisted machining with the axial mode and torsion mode vibrations (i.e. the tool strikes the workpiece in axial direction and generates torsion motion to grind the workpiece at the same time) can be accomplished by the special structure design of the cutting tool holder (such as the spiral structure). However, the structural design of the cutting tool holder is very complicated and difficult to manufacture, which greatly increases the cost. Besides, change of cutting tool of different size and weight is often needed in machining different work materials or for different machining purposes. In this case, the ultrasonic vibration supply unit needs to find the vibration frequency of the cutting tool including linear and torsion motion separately, or replacement of the cutting tool holder to match up with the cutting tool is required so that the cutting tool with the linear and torsion motion at the same vibration frequency can be maintained. It is clear that the methods of the prior art not only reduces machining efficiency but also increases costs.

### SUMMARY OF THE INVENTION

Therefore, the present invention provides an ultrasonic vibration assisted machining device to solve the problems of the prior art.

In one embodiment of the present invention, the ultrasonic vibration assisted machining device is applied for a cutting tool. The ultrasonic vibration assisted machining device includes a vibrating component and a spinning component. The vibrating component includes a main body. The main body includes a first end surface, a second end surface and a central axis. The first end surface and the second end surface are oppositely configured at two ends of the main body. The vibrating component is configured to receive an electrical power and generate a vibration with a vibrating frequency in the central axis direction according to the electrical power. The spinning component includes a first surface. The first surface is connected to the second end surface of the vibrating component. The area of the first surface is greater than that of the second end surface. The spinning component generates a spinning motion centered on the central axis according to the vibration with the vibrating frequency generated by the vibrating component. Wherein, the spinning component is connected to the cutting tool and transmits the vibration and the spinning motion to the cutting tool.

Wherein, the spinning component includes a first groove structure configured on the first surface and arranged around the vibration component.

Furthermore, the shape of the first groove structure is an arc shape.

Wherein, the vibrating component is a piezoelectric component.

In one embodiment, the ultrasonic vibration assisted machining device further includes a fixing component connected to the first end surface of the vibrating component to fix the vibrating component and the spinning component on a working machine.

Furthermore, the ultrasonic vibration assisted machining device includes a pre-tightening screw configured to fix the fixing component, the vibrating component and the spinning component.

Wherein, the spinning component includes a second surface and a mounting hole. The second surface is opposite to the first surface. The mounting hole is configured on the second surface and configured to fix the cutting tool.

Furthermore, the spinning component includes a second groove structure and a plurality of hole structures. The second groove structure and the hole structures are configured on the second surface. The hole structures and the second groove structure are arranged around the mounting hole. The hole structures and the central axis of the vibrating component form an angle respectively.

In one embodiment, the ultrasonic vibration assisted machining device further includes a power supply connected to the vibrating component. The power supply provides the electrical power to the vibrating component for generating the vibration.

Furthermore, the electrical power includes a first voltage switching frequency and a second voltage switching frequency. The vibrating component generates a first vibration and a second vibration according to the first voltage switching frequency and the second voltage switching frequency, and the first vibration and the second vibration are corresponding to the spinning motion.

In summary, the ultrasonic vibration assisted machining device of the present invention can generate axial vibration or torsional vibration through the vibrating component and the spinning component, so that the tool can vertically strike and grind the workpiece, thereby improving the machining accuracy and efficiency. Furthermore, the spinning component can generate the torsion mode through the first groove structure, the second groove structure and the hole structures, thereby saving the machining time. Moreover, the ultrasonic vibration assisted machining device of the present invention drives the cutting tool to machine the workpiece by the vibrations of the vibrating component and the spinning component. When the cutting tool of the ultrasonic vibration assisted machining device is changed during the process, the ultrasonic vibration assisted machining device does not need to replace the spinning structure to match up with the cutting tool, but only needs to find the vibrating frequency of the spinning motion of the spinning component and the cutting tool to increase efficiency and reduce costs.

### BRIEF DESCRIPTION OF THE APPENDED DRAWINGS

FIG. 1 is a schematic diagram illustrating an ultrasonic vibration assisted machining device according to an embodiment of the present invention.

FIG. 2 is a side view diagram illustrating the ultrasonic vibration assisted machining device in FIG. 1.

FIG. 3 is a sectional schematic diagram illustrating the ultrasonic vibration assisted machining device in FIG. 1.

FIG. 4 is a bottom view diagram illustrating the ultrasonic vibration assisted machining device in FIG. 1.

FIG. 5 is a schematic diagram illustrating the ultrasonic vibration assisted machining device and the cutting tool according to an embodiment of the present invention.

FIG. 6 is a schematic diagram illustrating the ultrasonic vibration assisted machining device and the power supply according to an embodiment of the present invention.

### DETAILED DESCRIPTION OF THE INVENTION

For the sake of the advantages, spirits and features of the present invention can be understood more easily and clearly, the detailed descriptions and discussions will be made later by way of the embodiments and with reference of the diagrams. It is worth noting that these embodiments are merely representative embodiments of the present invention, wherein the specific methods, devices, conditions, materials and the like are not limited to the embodiments of the present invention or corresponding embodiments. Moreover, the devices in the figures are only used to express their corresponding positions and are not drawing according to their actual proportion.

In addition, the indefinite articles “a” and “one” before the device or component have no limitation on the quantity requirement (such as the number of appearances) of the device or component. Therefore, “a” and “one” should be interpreted as including one or at least one, and a device or component in the singular form also includes the plural form, unless the number clearly refers to the singular form.

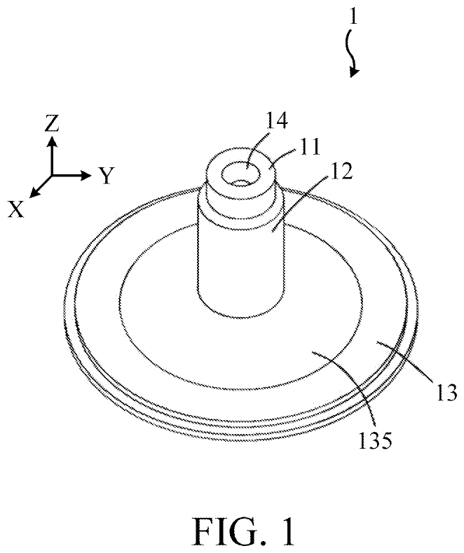

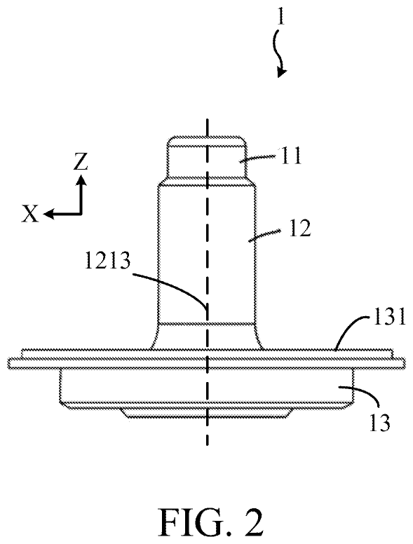

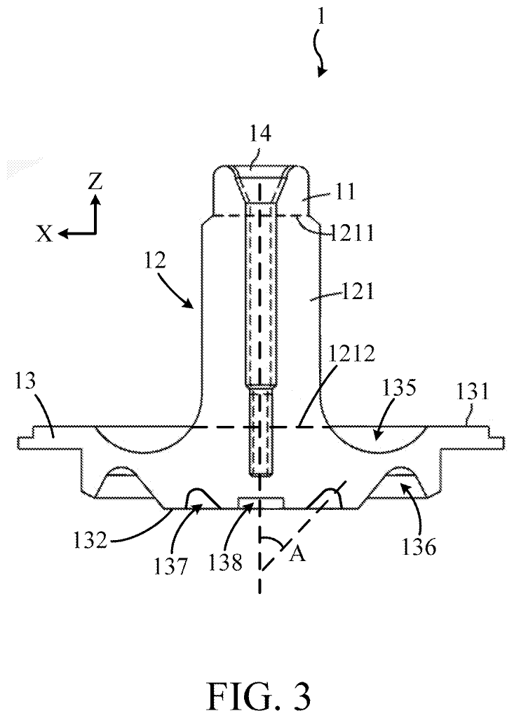

Please refer to FIG. 1, FIG. 2 and FIG. 3. FIG. 1 is a schematic diagram illustrating an ultrasonic vibration assisted machining device 1 according to an embodiment of the present invention. FIG. 2 is a side view diagram illustrating the ultrasonic vibration assisted machining device 1 in FIG. 1. FIG. 3 is a sectional schematic diagram illustrating the ultrasonic vibration assisted machining device 1 in FIG. 1. The ultrasonic vibration assisted machining device 1 of the present invention can be applied to a cutting tool. In this embodiment, the ultrasonic vibration assisted machining device 1 includes a fixing component 11, a vibrating component 12 and a spinning component 13. The fixing component 11 is connected to one end of the vibrating component 12, and the other end of the vibrating component 12 is connected to the spinning component. In practice, one end of the fixing component 11 can be connected to a working machine (not shown in figure), and the other end of the fixing component 11 is connected to the vibrating component 12. The fixing component 11, the vibrating component 12 and the spinning component 13 can be arranged in order along the direction of a central axis 1213. The cutting tool can be configured on the spinning component 13, and the workpiece can be configured below the spinning component 13.

In this embodiment, the vibrating component 12 includes a main body 121. The main body 121 includes a first end surface 1211, a second end surface 1212 and the central axis 1213. The first end surface 1211 and the second end surface 1212 are oppositely configured at two ends of the main body 121. The vibrating component 12 is configured to receive an electrical power and generate a vibration with a vibrating frequency in the central axis 1213 direction according to the electrical power. In practice, the vibrating component 12 can be a cylinder, and the central axis 1213 is the axis of the cylinder. The first end surface 1211 and second end surface 1212 are located at two ends of the cylinder respectively. The first end surface 1211 of the vibrating component 12 is connected to the fixing component 11. Because the fixing component 11 is fixed on the working machine, the first end surface 1211 of the vibrating component 12 is fixed and the vibrating component 12 vibrates via the second end surface 1212 when the vibrating component 12 generates the vibration. The vibrating component 12 can be a piezoelectric component formed by multiple piezoelectric elements (such as the piezoelectric plate formed by piezoelectric material). Therefore, when the piezoelectric component receives the electrical power, the piezoelectric component expands or contracts according to the electric energy to generate the vibration. Furthermore, the direction of expansion and contraction of the piezoelectric component is the same as the direction of the central axis 1213. That is to say, when the vibrating component 12 receives electric energy, the vibration component 12 generates a linear vibration with a vibrating frequency in the direction of the central axis 1213 (the Z-axis direction in FIG. 1). The vibration component 12 is not limited to be the aforementioned piezoelectric component, and the vibration component 12 also can be another types. In another one embodiment, the vibration component 12 is a magnetostrictive component, and the material of the vibration component 12 can be magnetic material. When the vibrating component 12 receives electric power, the vibrating component 12 generates a magnetostriction phenomenon due to the change of the magnetic field to change the length of the vibrating member 12, thereby generating vibration.

As shown in FIG. 3, in this embodiment, the spinning component 13 includes a first surface 131. The first surface 131 is connected to the second end surface 1212 of the vibrating component 12, and the area of the first surface is greater than that of the second end surface 1212. The spinning component 13 may be a disc-shaped component, and the first surface 131 of the spinning component 13 may contact the second end surface 1212 of the vibration component 12. When the vibration component 12 vibrates with a vibrating frequency, the vibration component 12 may transmit the vibration to the spinning component 13, so that the spinning component 13 vibrates with the vibrating frequency and generates a vibrating mode corresponding to the vibrating frequency. In practice, the vibrating mode of the spinning component 13 may include the linear vibration in the same direction as the vibration of the vibrating component 12 and the torsion motion centered on the central axis 1213 of the vibration member 12. Furthermore, the vibration mode of the spinning component 13 may be corresponding to a plurality of vibrating frequency. For example, the spinning component 13 has the linear vibrating modes along the Z-axis at 28.7 KHz and 58.2 KHz, and the spinning component 13 has the torsion modes at 20.5 KHz, 53.8 KHz, 80.2 KHz, 89.3 KHz, 122 KHz, 130 KHz, and 151 KHz. Moreover, the axis of the spinning component 13 and the central axis 1213 of the vibration component 12 are located on the same straight line. When the vibration component 12 transmits the vibration to the spinning component 13, the spinning component 13 can uniformly transmit the vibration in the center of the disc to the outer edge.

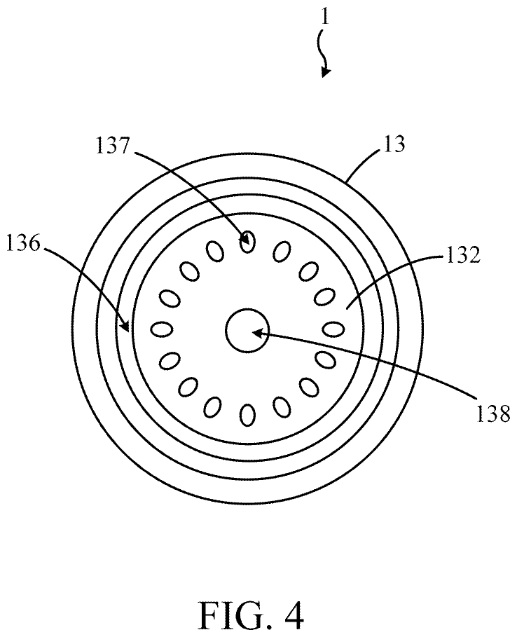

Please refer to FIG. 1, FIG. 3 and FIG. 4. FIG. 4 is a bottom view diagram illustrating the ultrasonic vibration assisted machining device 1 in FIG. 1. In this embodiment, the spinning component 13 includes a second surface 132, a first groove structure 135, a second groove structure 136 and a plurality of hole structures 137. The second surface 132 is corresponding to the first surface 131. The first groove structure 135 is configured on the first surface 131 and arranged around the vibration component 12. The second groove structure 136 and the hole structures 137 are configured on the second surface 132. Furthermore, the hole structures 137 are arranged in a ring shape, and the second groove structure 136 is arranged around the hole structures 137. The first groove structure 135 may be the annular groove of FIG. 1, the second groove structure 136 may also be an annular groove, and the cross-sectional shapes of the first groove structure 135 and the second groove structure 136 may be arc shape, but it is not limited hereto. Each of the hole structures 137 and the central axis 1213 of the vibration component 12 form an angle A. Because each of the hole structures 137 has the angle A, the thick of the spinning component 13 is changed. The angle A may be 10˜20 degrees, but it is not limited hereto; the angle A also can be adjusted according to the design of the hole structures 137. As shown in FIG. 3, the thickness of the spinning component 13 in the hole structures 137 gradually changes from the axis to the outer edge. When the vibrating component 12 drives the spinning component 13 to vibrate in the Z-axis direction, the spinning component 13 is more likely to change the vibration mode at the position where the thickness changes. Furthermore, because each of the hole structures 137 has an angle A, the hole structures 137 can change the thickness of the spinning component 13 by the angle A, so that the spinning component 13 is deformed in the X-axis direction. That is to say, the vibration provided by the vibrating component 12 in the Z-axis direction is split into part of the Z-axis vibration and part of the X-axis vibration through the hole structures 137, so that the spinning component 13 expands or contracts in the radial direction (in the X-axis direction), thereby producing the torsional motion. Similarly, the first groove structure 135 and the second groove structure 136 are the arc-shape groove, so that the thickness of the spinning component 13 is changed at the first groove structure 135 and the second groove structure 136. Therefore, when the vibrating component 12 drives the spinning component 13 to vibrate, the spinning component 13 expands or contracts in the radial direction (in the X-axis direction) at the first groove structure 135 and the second groove structure 136, thereby producing the torsional motion. Therefore, when the vibrating component 12 drives the spinning component 13 to vibrate at the vibrating frequency of the torsion mode generated by the spinning component 13, the torsion mode and the vibrating frequency of the spinning component 13 are coupled to each other to generate torsional motion.

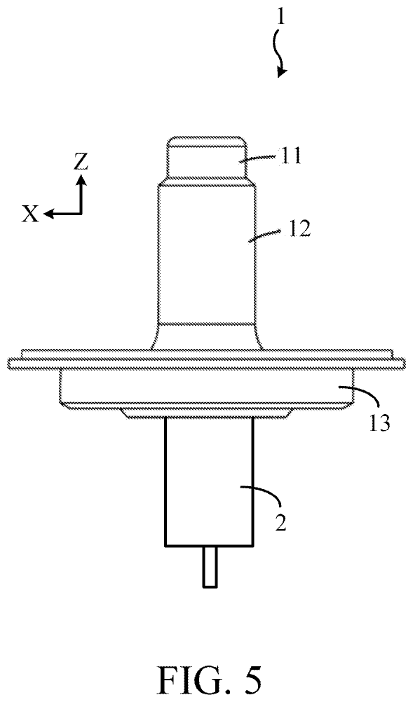

Please refer to FIG. 3 and FIG. 5. FIG. 5 is a schematic diagram illustrating the ultrasonic vibration assisted machining device 1 and the cutting tool 2 according to an embodiment of the present invention. In this embodiment, the spinning component 13 further includes a mounting hole 138. The mounting hole 138 is configured on the second surface 132 of the spinning component 13 and configured to fix the cutting tool 2. Furthermore, the center of the mounting hole 138 is located at the extended position of the central axis 1213 of the vibrating component 12, and the second groove structure 136 and the hole structures 137 of the spinning component 13 are arranged around the mounting hole 138. In practice, the cutting tool 2 includes a mounting structure matching up with the mounting hole 138 of the spinning component 13 to install to the mounting hole 138 via the mounting structure. When the cutting tool 2 is configured on the mounting hole 138 of the spinning component 13, the torsion motion generated by the spinning component 13 can be transmitted to the cutting tool 2, so that the cutting tool 2 can generate the torsion motion with the spinning component 13. Furthermore, the vibration generated by the vibrating component 12 also may be transmitted to the cutting tool 2 through the spinning component 13. Therefore, the tool 2 can vertically strike and grind the workpiece, thereby improving the machining efficiency. Moreover, the vibration mode of the cutting tool 2 is driven by the vibration mode generated by the vibrating component 12 and the spinning component 13. Therefore, when the cutting tool needs to be replaced during the machining process, the ultrasonic vibration assisted machining device only needs to search the vibration mode of the torsion motion of the spinning component 13 and the cutting tool 2 without replacing the cutting tool holder matching up with the cutting tool, thereby saving costs and machining time.

Please refer to FIG. 3. As shown in FIG. 3, in this embodiment, the ultrasonic vibration assisted machining device 1 further includes a pre-tightening screw 14. The pre-tightening screw 14 is configured to fix the fixing component 11, the vibrating component 12 and the spinning component 13. In practice, the fixing component 11, the vibrating component 12 and the spinning component 13 include a screw hole structure matching up with the pre-tightening screw 14. The pre-tightening screw 14 can pass through the fixing component 11, the vibrating component 12 and the spinning component 13 to connect the three ones tightly to ensure that the vibration generated by the vibrating component 12 can be completely transmitted to the torsion member 13, thereby improving machining efficiency and accuracy.

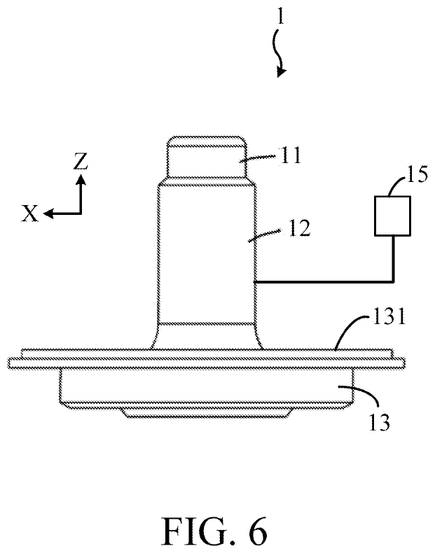

Please refer to FIG. 6. FIG. 6 is a schematic diagram illustrating the ultrasonic vibration assisted machining device 1 and the power supply 15 according to an embodiment of the present invention. In this embodiment, the ultrasonic vibration assisted machining device 1 further includes the power supply 15 connected to the vibrating component 12. The power supply 15 is configured to provide the electrical power to the vibrating component 12 for generating the vibration. In practice, the electrical power provided by the power supply 15 may be alternating current, and the alternating current includes a voltage switching frequency. The voltage switching frequency may be the vibrating frequency generated by the vibrating component 12, and the vibrating component 12 may generate a vibration of the corresponding vibrating frequency according to the voltage switching frequency provided by the power supply 15. Moreover, the power supply 15 can provide electric energy in a frequency range, and the power supply 15 can vibrate the vibrating component 12 at different frequencies by sweeping the frequency, so that the spinning component 13 can generate the torsion motion at a specific frequency. For example, the power supply 15 can provide the electrical power from 50 Hz to 100 Hz to drive the vibrating component 12. At this time, the vibrating component 12 vibrates the spinning component 13 from 50 Hz to 100 Hz respectively. The spinning component 13 generates the torsion motion when the vibrating frequencies are 80.2 KHz and 89.3 KHz. It should be noted that the range of the voltage switching frequency provided by the power supply 15 is not limited hereto, and the range of the voltage switching frequency may be determined according to the design or requirements. Therefore, when the cutting tool needs to be replaced during the machining process, the ultrasonic vibration assisted machining device only needs to search the vibration mode of the torsion motion of the spinning component 13 and the cutting tool 2, thereby saving machining time and increasing the machining efficiency.

In summary, the ultrasonic vibration assisted machining device of the present invention can generate axial vibration or torsional vibration through the vibrating component and the spinning component, so that the tool can vertically strike and grind the workpiece, thereby improving the machining accuracy and efficiency. Furthermore, the spinning component can generate the torsion mode through the first groove structure, the second groove structure and the hole structures, thereby saving the machining time. Moreover, the ultrasonic vibration assisted machining device of the present invention drives the cutting tool to process the workpiece by the vibrations of the vibrating component and the spinning component. When the cutting tool of the ultrasonic vibration assisted machining device is changed during the process, the ultrasonic vibration assisted machining device does not need to replace the spinning structure matching up with the cutting tool, but only needs to find the vibrating frequency of the spinning motion of the spinning component and the cutting tool to increase efficiency and reduce costs.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An ultrasonic vibration assisted machining device, applied to a cutting tool, the ultrasonic vibration assisted machining device comprising:
a vibrating component, comprising a main body, the main body comprising a first end surface, a second end surface and a central axis, the first end surface and the second end surface being oppositely configured at two ends of the main body, the vibrating component being configured to receive an electrical power and generate a vibration with a vibrating frequency in the central axis direction according to the electrical power; and
a spinning component, comprising a first surface, the first surface being connected to the second end surface of the vibrating component, the area of the first surface being greater than that of the second end surface, the spinning component generating a spinning motion centered on the central axis according to the vibration with the vibrating frequency generated by the vibrating component;
wherein, the spinning component is connected to the cutting tool and transmits the vibration and the spinning motion to the cutting tool.

2. The ultrasonic vibration assisted machining device of claim 1, wherein the spinning component comprises a first groove structure configured on the first surface and arranged around the vibrating component.

3. The ultrasonic vibration assisted machining device of claim 2, wherein the shape of the first groove structure is an arc shape.

4. The ultrasonic vibration assisted machining device of claim 1, wherein the vibrating component is a piezoelectric component.

5. The ultrasonic vibration assisted machining device of claim 1, further comprising a fixing component connected to the first end surface of the vibrating component to fix the vibrating component and the spinning component on a working machine.

6. The ultrasonic vibration assisted machining device of claim 5, further comprising a pre-tightening screw configured to fix the fixing component, the vibrating component and the spinning component.

7. The ultrasonic vibration assisted machining device of claim 1, wherein the spinning component comprises a second surface and a mounting hole, the second surface is opposite to the first surface, the mounting hole is configured on the second surface and configured to fix the cutting tool.

8. The ultrasonic vibration assisted machining device of claim 7, wherein the spinning component comprises a second groove structure and a plurality of hole structure, the second groove structure and the hole structures are configured on the second surface, the hole structures are arranged around the mounting hole and the second groove structure is arranged around the hole structures, the hole structures and the central axis of the vibrating component form an angle respectively.

9. The ultrasonic vibration assisted machining device of claim 1, further comprising a power supply connected to the vibrating component, the power supply providing the electrical power to the vibrating component for generating the vibration.

10. The ultrasonic vibration assisted machining device of claim 9, wherein the electrical power comprises a first voltage switching frequency and a second voltage switching frequency, the vibrating component generates a first vibration and a second vibration according to the first voltage switching frequency and the second voltage switching frequency, and the first vibration and the second vibration are corresponding to the spinning motion.
